(19) United States
(12) Patent Application Publication
(10) Pub. No.: US 2026/0362463 A1
(43) Pub. Date: Nov. 12, 2026

(54) DEVICE AND METHOD FOR PROVIDING AN INPUT VARIABLE FOR A SCHEDULER FOR A WIRELESS COMMUNICATION NETWORK, DEVICE AND METHOD FOR PROVIDING INFORMATION FOR PROVIDING THE INPUT VARIABLE

(71) Applicant: Robert Bosch GmbH, Stuttgart (DE)

(72) Inventors: David Osamu Ginthoer, Stuttgart (DE); Marie-Theres Suer, Braunschweig (DE); Rene Guillaume, Boeblingen (DE)

(21) Appl. No.: 19/658,963

(22) Filed: Apr. 27, 2026

(30) Foreign Application Priority Data
May 8, 2025 (DE) 10 2025 117 663.9

(51) Int. Cl. H04W 72/51

(52) U.S. Cl. CPC H04W 72/51

(57) ABSTRACT

A method and device for providing an input variable for a scheduler for a wireless communication network, The communication network comprises a first access point and a bridge for time-synchronized and deterministic communication, wherein the first access point is configured to provide a first radio channel for communication, wherein the first radio channel comprises the bridge, wherein information is received, wherein the information comprises a property of the first radio channel or of the first access point, wherein the input variable is determined according to the property, wherein the input variable comprises a condition or an optimization objective for the scheduler, and wherein the input variable is provided to the scheduler.

### CROSS REFERENCE

The present application claims the benefit under 35 U.S.C. § 119 of Germany Patent Application No. DE 10 2025 117 663.9 filed on May 8, 2025, which is expressly incorporated herein by reference in its entirety.

### FIELD

The present disclosure relates to a device and a method for providing an input variable for a scheduler for a wireless communication network. The present disclosure relates to a device and a method for providing information for providing the input variable.

### BACKGROUND INFORMATION

Time-Sensitive Networking (TSN) denotes network protocols and standards of the IEEE 802.1 TSN working group for communication networks. TSN aims to improve the performance of time-critical communication.

### SUMMARY

According to an example embodiment of the present disclosure, a method is provided for providing an input variable for a scheduler for a wireless communication network, wherein the communication network comprises a first access point and a bridge for time-synchronized and deterministic communication, wherein the first access point is configured to provide a first radio channel for communication, wherein the first radio channel comprises the bridge, wherein information is received, wherein the information comprises a property of the first radio channel or of the first access point, wherein the input variable is determined according to the property, wherein the input variable comprises a condition or an optimization objective for the scheduler, and wherein the input variable is provided to the scheduler.

By means of the method, the performance of time-synchronized and deterministic communication in a wireless communication network is improved. The communication network can be configured as a Wi-Fi network, e.g., according to IEEE 802.11ax (WiFi 6) or IEEE 802.11be (WiFi 7).

The communication network comprises a first access point and a bridge for time-synchronized and deterministic communication. The first access point is configured to provide a first radio channel for communication, wherein the first radio channel comprises the bridge.

The method for providing an input variable for a scheduler for the wireless communication network provides that information is received, wherein the information comprises a property of the first radio channel or of the first access point, wherein the input variable is determined according to the property, wherein the input variable comprises a condition or an optimization objective for the scheduler, and wherein the input variable is provided to the scheduler.

It can be provided that the first access point makes possible, up to a maximum number of users, a simultaneous transmission of data of a plurality of users, wherein the property comprises the maximum number of users. The maximum number of users represents information particularly suitable for improving the performance.

It can be provided that the communication network comprises a second access point, wherein the property indicates that the second access point provides a second radio channel that leads to interference in the first radio channel. The property that indicates that the second access point provides a second radio channel that leads to interference in the first radio channel represents information that is particularly suitable for improving the performance.

It can be provided that the property characterizes a duration of a delay until the start of a transmission by the first access point via the first radio channel. The duration represents information particularly suitable for improving the performance.

It can be provided that the communication network comprises resources for providing the radio channels, and the scheduler is configured to assign, to a data stream, the resources for transmitting the data stream in the communication network according to the input variable, wherein the input variable is provided to the scheduler prior to an initial assignment of the resources.

It can be provided that a request of an application for transmitting data via the communication network is provided, wherein the input variable is determined according to the request. The request represents information particularly suitable for improving the performance.

It can be provided that the information comprises a property of another radio channel, wherein the input variable is determined according to the property of the other radio channel, or that the information comprises a property of another access point, wherein the input variable is determined according to the property of the other access point, wherein the property comprises a maximum number of users of the other access point or radio channel, or wherein the property indicates that the first radio channel leads to interference in the other radio channel, or wherein the property characterizes a duration of a delay until the start of a transmission by the other access point via the other radio channel. The property of the second radio channel represents information particularly suitable for improving the performance.

For example, the information is received in a unit in a central control unit for the communication network, the input variable is determined in the unit according to the received information, and is provided to the scheduler.

For example, the information is received in a unit outside a central control unit for the communication network, the input variable is determined in the unit according to the received information, and is provided to the scheduler.

According to an example embodiment, a method for providing the information provides that data with respect to a first radio channel for determining the information are measured by a first access point, wherein the first access point provides the first radio channel, the measured data are evaluated by the first access point, the information is generated by the first access point, and the information is sent by the first access point, wherein the information comprises at least one property of the first radio channel or of the first access point, wherein the data characterize the property.

The method for providing the information provides, for example, that the data and the property characterize an interference in the first radio channel, in particular an indicator for the interference, and/or that the data and the property characterize a duration of the delay until the start of the transmission by the first access point via the first radio channel, that the data and the property characterize the transmissions on the first radio channel, in particular a percentage and/or a distribution of time in which transmission via the first radio channel is performed or is not performed, and/or that the data and the property characterize a maximum number of users of the first access point, and/or that the data and the property characterize a frequency band currently used by the first access point, and/or that the data and the property characterize a current property of the communication network in the environment of the first access point, and/or that the data and the property characterize a property of a user of the first access point, and/or that the data and the property characterize an identification of a second access point that provides a second radio channel causing the interference in the first radio channel.

According to an example embodiment, a device for providing the input variable for the scheduler for the wireless communication network provides that the device for providing the input variable is configured to perform the method for providing the input variable according to the present disclosure.

According to an example embodiment, a device for providing the information provides that the device for providing the information is configured to perform the method for providing the information according to the present disclosure.

According to an example embodiment, a computer program provides that the computer program comprises commands or instructions which are readable by a computer or one of the disclosed devices and which cause the computer and/or the device to perform the method for providing the input variable and/or for providing the information according to the present disclosure.

Furthermore, a (machine-readable) storage medium is proposed on which the computer program is stored.

Further examples can be found in the following description and the figures.

### BRIEF DESCRIPTION OF THE DRAWINGS

FIG. 1 schematically shows a first scheduling, according to an example embodiment.

FIG. 2 schematically shows a second scheduling, according to an example embodiment.

FIG. 3 schematically shows a first transmission, according to an example embodiment.

FIG. 4 schematically shows a second transmission, according to an example embodiment.

FIG. 5 schematically shows a communication network, according to an example embodiment.

FIG. 6 schematically shows a device in the communication network, according to an example embodiment.

FIG. 7 shows a flow diagram, according to an example embodiment.

### DETAILED DESCRIPTION OF EXAMPLE EMBODIMENTS

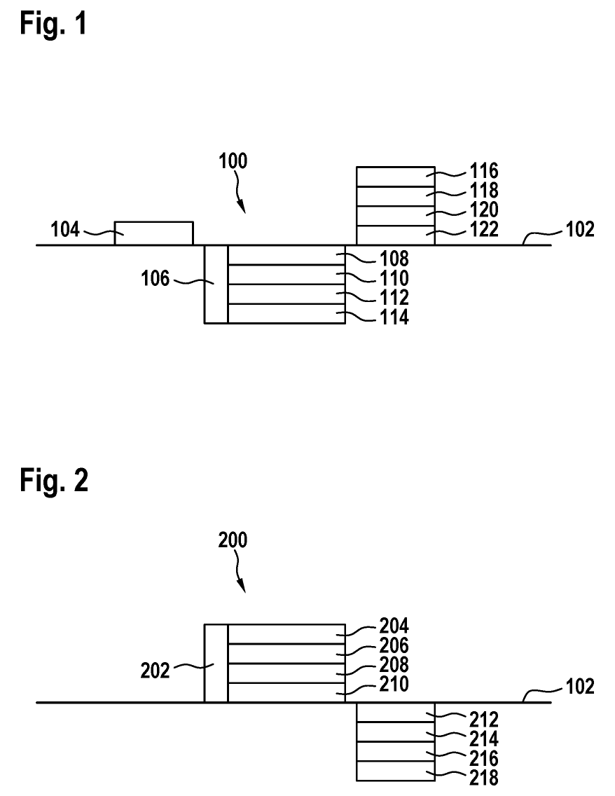

In FIG. 1, a first scheduling 100 of frames in an uplink (UL) is shown schematically over time 102.

The first scheduling 100 provides a time slot for a transmission of a first frame 104 by an access point. The first frame 104 is, e.g., a trigger.

The first scheduling 100 then provides a time slot for a transmission 106 of a plurality of stations in a multiplexing method. In the example, a frame 108 for a first station, a frame 110 for a second station, a frame 112 for a third station and a frame 114 for a fourth station are shown.

The first scheduling 100 then provides a time slot for a transmission of frames of a base station in a multiplexing method to a plurality of stations. In the example, a frame 116 to a first station, a frame 118 to a second station, a frame 120 to a third station, and a frame 122 to a fourth station are shown.

An example of the multiplexing method is orthogonal frequency division multiple access (OFDMA). OFDMA is, e.g., described in IEEE 802.11ax (WiFi 6) and IEEE 802.11be (WiFi 7). OFDMA makes possible the simultaneous transmission to a plurality of stations or from a plurality of stations to a base station. For example, grouping of orthogonal frequency division multiplexing (OFDM) subcarriers into resource units for the transmission is provided. OFDMA makes triggered UL access (TUA) by means of the trigger possible. OFDMA makes multiuser enhanced distributed channel access (MU EDCA) possible. OFDMA makes it possible for access points to control the transmission medium based on priority. By means of TUA, the access points can multiplex the transmission of a plurality of stations in the UL.

In FIG. 2, a second scheduling 200 of frames in a downlink (DL) is shown schematically over time 102.

The second scheduling 200 provides a time slot for a transmission 202 to the plurality of stations in the multiplexing method. In the example, a frame 204 for the first station, a frame 206 for the second station, a frame 208 for the third station and a frame 210 for the fourth station are shown.

The second scheduling 200 then provides a time slot for a transmission from a base station in a multiplexing method to a plurality of stations. In the example, a frame 212 to the station, a frame 214 to the second station, a frame 216 to the third station and a frame 218 to the fourth station are shown.

The access points can be configured for scheduling time-synchronized and deterministic communication. An example of time-synchronized and deterministic communication is time-sensitive networking (TSN). The access points are, e.g., TSN-capable. The access points can be configured as access points of a WiFi system, e.g., according to IEEE 802.11ax (WiFi 6) and IEEE 802.11be (WiFi 7).

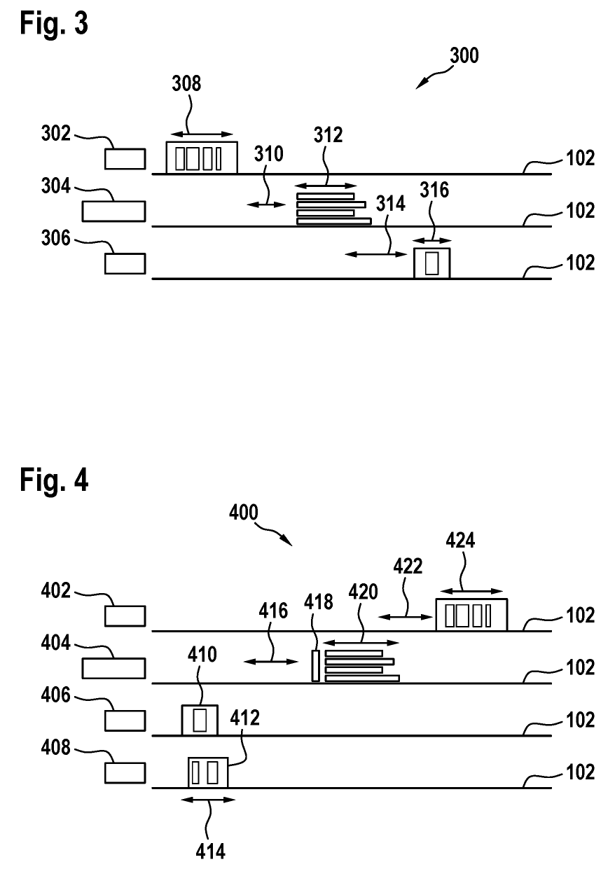

In FIG. 3, a sequence 300 of a DL transmission for a bridge 302 to an access point, a connection 304 from the access point to the first station, the second station, the third station and the fourth station, and for a connection 306 from the first station to an endpoint is shown schematically over time 102.

The bridge 302 is configured for time-synchronized and deterministic communication. The bridge 302 is, e.g., a TSN bridge.

In the DL transmission, a first time window 308 of the DL transmission is provided for transmitting time-critical frames via the bridge 302.

After the first time window 308 of the DL transmission, a first time period 310 arises in the connection 304 of the DL transmission, in which first time period there is uncertainty due to delays in accessing the medium. After the first time period 310 of the DL transmission, frames are transmitted via the connection 304 of the DL transmission in a second time period 312 of the DL transmission. This can take place simultaneously by means of the multiplexing method to a plurality of stations.

After the second time period 312 of the DL transmission, a third time period 314 of the DL transmission arises in the connection 306 from the first station to the endpoint, in which third time period there is uncertainty due to delays in transmitting the frames.

The uncertainty in the transmission results from the data size of the packets that are sent to the particular station and the available transmission rate, which results from the modulation and coding method used according to the channel quality.

After the third time period 314 of the DL transmission, a second time window 316 of the DL transmission is available in the first station 306 for transmitting time-critical frames.

The first time window 308 of the DL transmission and the second time window 316 of the DL transmission are reserved for time-critical frames. This means that access for non-time-critical frames is prohibited.

In FIG. 4, a sequence 400 of a UL transmission for a bridge 402 to a plurality of endpoints, a connection 404 of the UL transmission from the first station, the second station, the third station and the fourth station to the access point, for the connection 406 from a first endpoint to the first station, and a connection 408 from a second endpoint to the second station is shown schematically over time 102.

In a first time window 410 of the UL transmission, frames of the connection 406 from the first endpoint to the first station are transmitted.

In a second time window 412 of the UL transmission, frames of the connection 408 from the second endpoint to the second station are transmitted in a first time period 414 of the UL transmission, which is available for transmitting time-critical frames.

The second time window 412 of the UL transmission begins during the first time window 410 of the UL transmission and lasts longer than the first time window 410 of the UL transmission.

After the second time window 412 of the UL transmission, a second time period 416 of the UL transmission arises in the connection 404 of the UL transmission, in which second time period there is uncertainty due to delays in accessing the medium. After the second time period 416 of the UL transmission, a frame 418 for initiating the transmission of frames via the connection 404 of the UL transmission is transmitted via the connection 404 of the UL transmission. The frame 418 for initiating is, e.g., a trigger. Start and end time points of the transmission are arranged in such a way that the first time window 410 and the second time window 412 are completed before the frame 418 for initiating the transmission of frames via the connection 404 is sent.

After the frame 418 for initiating, frames are transmitted via the connection 404 of the UL transmission in a third time period 420 of the UL transmission.

After the third time period 420 of the UL transmission, a third time window 422 of the UL transmission is available in the bridge 402 for transmitting time-critical frames.

Before the third time window 422 of the UL transmission, a fourth time period 424 arises in the bridge 402, in which fourth time period there is uncertainty due to delays in transmitting the frames. The fourth time period 424 of the UL transmission begins during or after the third time period of the UL transmission or follows the third time period 422 of the UL transmission.

The first time period 414 and the fourth time period 424 are reserved for time-critical frames. This means that access for non-time-critical frames is prohibited.

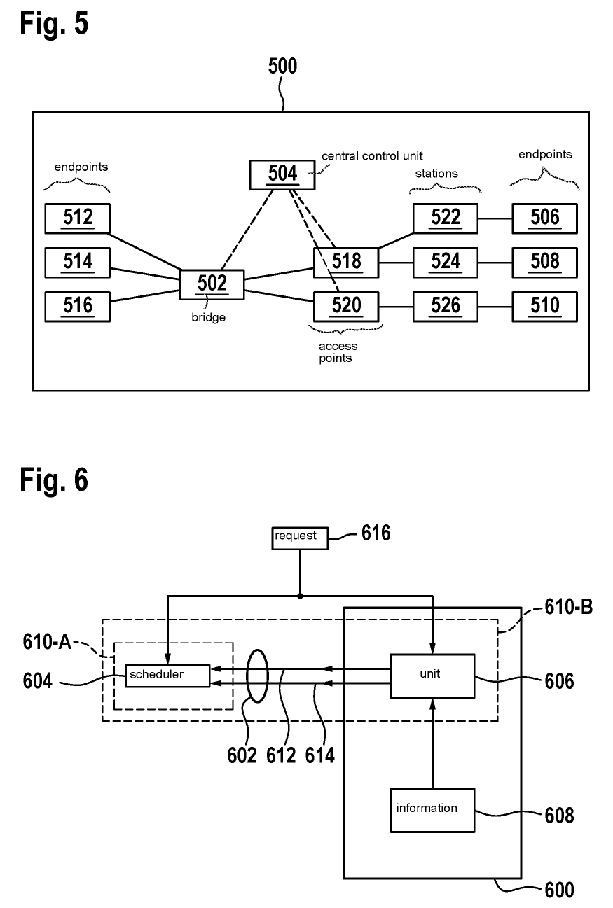

In FIG. 5, an example 500 for the communication network is shown schematically.

The communication network according to the example 500 comprises a bridge 502 and a central control unit 504 for the communication network, the first endpoint 506, the second endpoint 508, a third endpoint 510, a fourth endpoint 512, a fifth endpoint 514, a sixth endpoint 516, a first access point 518, a second access point 520, the first station 522, the second station 524, and a third station 526.

The bridge 501 is connected to the first access point 518, the second access point 520, the third endpoint 512, the fourth endpoint 514 and the fifth endpoint 516, in each case via a communication connection for transmitting frames. The first access point 518 is connected to the first station 522 via a communication connection for transmitting frames. The first access point 518 is connected to the second station 524 via a communication connection for transmitting frames. The second access point 520 is connected to the third station 526 via a communication connection for transmitting frames.

The first station 522 is connected to the first endpoint 506 via a communication connection for transmitting frames. The second station 524 is connected to the second endpoint 508 via a communication connection for transmitting frames. The third station 526 is connected to the third endpoint 510 via a communication connection for transmitting frames.

The central control unit 504 is connected via a particular communication connection to the access points 518, 520, and to the bridge 502.

In FIG. 6, a device 600 in the communication network for providing an input variable 602 for a scheduler 604 for the communication network is shown schematically.

The communication network comprises resources for providing radio channels. The scheduler 604 is configured to assign, to a data stream, the resources for transmitting the data stream in the communication network according to the input variable 602.

The device 600 comprises a unit 606. The unit 606 is configured to receive information 608. The information 608 comprises a property of at least one radio channel or at least one access point of the communication network. The property comprises, e.g., a maximum number of users of at least one access point or radio channel. The property indicates, for example, that one of the radio channels leads to interference in another of the radio channels. The property characterizes, e.g., a duration of a delay until the start of a transmission by one of the access points via one of the radio channels.

The unit 606 is configured to determine the input variable 602 according to the received information 608. The information 608 can comprise a plurality of properties. The unit 606 is configured to determine the input variable 602 according to one property from the received information 608 or a plurality of properties from the received information 608.

According to a first example 610-A, the unit 606 is arranged outside the central control unit 504 for the communication network.

According to a second example 610-B, the unit 606 is arranged within the central control unit 504 for the communication network.

The scheduler 604 is arranged in the example in the central control unit 504. It can also be provided that the scheduler 604 is arranged outside the central control unit 504.

The input variable 602 comprises, e.g., a condition 612 or an optimization objective 614 for the scheduler 604.

It can be provided that the unit 606 is configured to receive a request 616 of an application and to determine the input variable 602 according to the request 616.

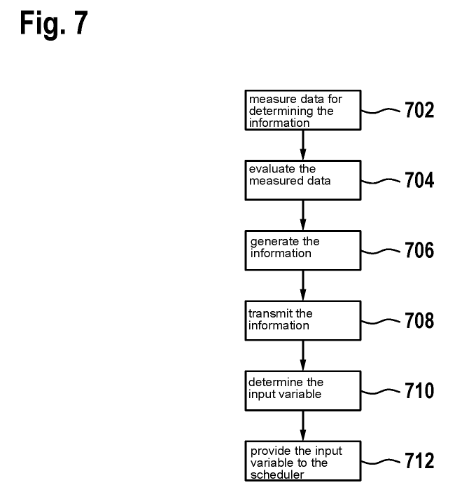

In FIG. 7, a flow diagram of a method for providing the input variable 602 for the scheduler 604 is shown.

The method provides that the communication network comprises the first access point 518 and the bridge 502 for time-synchronized and deterministic communication.

The first access point 518 is configured to provide a first radio channel for communication. The first radio channel comprises the bridge 502.

The first access point 518 is configured to measure data for determining the information 608.

The data characterize, e.g., a strength of an interference in the first radio channel. The data characterize, e.g., an indicator for the interference. The indicator is, e.g., an RSSI value.

The data characterize, e.g., a duration of a delay until the start of a transmission by the first access point 518 via the first radio channel. The duration is estimated, for example, by a base station or by a plurality of base stations. For example, the number of neighboring base stations is determined based on beacon signals.

The data characterize, e.g., transmissions on the first radio channel.

The data characterize, e.g., a percentage or a distribution of time in which transmission via the first radio channel is performed or is not performed. For example, an occupancy of a channel is measured based on a measurement of the channel busy time by a base station or by a plurality of base stations. The measured channel busy times are used, e.g., for statistical estimations regarding the delay until the start of a transmission by an access point.

It can be provided that the first access point 518 makes possible, up to a maximum number of users, a simultaneous transmission of data of a plurality of users. It can be provided that the data characterize the maximum number of users. To what extent a plurality of stations can transmit simultaneously in the multiplexing method depends substantially on channel properties of the individual stations. For example, channel state information for a station or for the stations is evaluated by the base station in order to determine the maximum number of users and the supported rate according to the channel state information.

The data characterize, e.g., a frequency band currently used by the first access point 518.

The data characterize, e.g., a current property of the communication network in an environment of the first access point 518.

The data characterize, e.g., a property of a user of the first access point 518.

For example, the access points are in each case associated with an identification. For example, the access points are configured to provide the identification.

This is described using the example of the communication network that comprises the second access point 520.

The data characterize, e.g., the identification of the second access point 520. This identification is provided, for example, by a beacon frame that is transmitted by the particular base station at regular time intervals.

The first access point 518 is configured to evaluate the measured data.

The first access point 518 is, e.g., configured to determine the strength of the interference in the first radio channel according to the data that characterize the interference in the first radio channel.

The first access point 518 is, e.g., configured to determine the duration of the delay until the start of the transmission by the first access point 518 via the first radio channel according to the data that characterize the duration.

The first access point 518 is, e.g., configured to determine the maximum number of users of the first access point 518 according to the data that characterize the maximum number of users of the first access point 518.

The first access point 518 is, e.g., configured to determine the maximum number by the first access point 518 on the basis of the frequency band currently used by the first access point 518, the current property of the communication network in the environment of the first access point 504, or the property of the user of the first access point 504.

The first access point 518 is, e.g., configured to determine an identification of the second access point 520 according to the data that characterize the identification of the second access point 520.

The first access point 518 is configured to generate the information 608 according to the evaluated data.

The information 608 comprises at least one property of the first radio channel or of the first access point 518.

The first access point 518 is, e.g., configured to determine the duration of the delay until the start of the transmission by the first access point 518 via the first radio channel as a property.

The first access point 518 is, e.g., configured to determine the duration of the delay according to the percentage or the distribution as a property.

It can furthermore be provided that the first access point 518 is configured to determine, according to the delay, when the first access point 518 sends a trigger for the first radio channel, or when a time window via the bridge 502 is available for the first radio channel.

The first access point 518 is, e.g., configured to determine the maximum number of users as a property.

If the communication network comprises the second access point 520 that provides the second radio channel that leads to interference in the first radio channel, it can be provided that the first access point 518 is configured to determine a property that indicates that the second access point 520 provides the second radio channel that leads to interference in the first radio channel.

For example, the first access point 518 is configured to provide the identification of the second access point 520 along with the indicator for the strength of the interference. The property comprises, e.g., the indicator and the identification of the second access point 520.

The first access point 518 is configured to provide the information 608 that characterizes at least one of the properties.

The information 608 characterizes, e.g., at least one property of the first radio channel or of the first access point 518. In the example, the information 608 comprises at least one property of the first radio channel or of the first access point 518.

The method comprises a step 702.

In step 702, data for determining the information 608 are measured by the first access point 518.

The data characterize, e.g., the interference in the first radio channel. The data characterize, e.g., the indicator for the interference. The indicator is, e.g., the RSSI value.

The data characterize, e.g., the duration of the delay until the start of the transmission by the first access point 518 via the first radio channel.

The data characterize, e.g., the transmissions on the first radio channel.

The data characterize, e.g., the percentage or the distribution of time in which transmission via the first radio channel is performed or is not performed.

It can be provided that the data characterize the maximum number of users.

The data characterize, e.g., the frequency band currently used by the first access point 518.

The data characterize, e.g., the current property of the communication network in the environment of the first access point 518.

The data characterize, e.g., the property of the user of the first access point 518.

The data characterize, e.g., the identification of the second access point 520.

The method comprises a step 704.

In step 704, the measured data are evaluated by the first access point 518.

For example, the strength of the interference in the first radio channel is determined according to the data that characterize the interference in the first radio channel.

For example, the duration of the delay until the start of the transmission by the first access point 518 via the first radio channel is determined according to the data that characterize the duration.

For example, the maximum number of users of the first access point 518 is determined according to the data that characterize the maximum number of users of the first access point 518.

The maximum number is, e.g., determined by the first access point 518 on the basis of the frequency band currently used by the first access point 518, the current property of the communication network in the environment of the first access point 518, or the property of the user of the first access point 518.

It can be provided that the maximum number is specified by a manufacturer of the control unit 504.

For example, the identification of the second access point 520 is determined according to the data that characterize the identification of the second access point 520.

The method comprises a step 706.

In step 706, the information 608 is generated.

The information 608 comprises at least one property of the first radio channel or of the first access point 518.

For example, the information 608 comprises the duration of the delay until the start of the transmission by the first access point 518 via the first radio channel as a property.

For example, the duration of the delay is determined as a property according to the percentage or the distribution.

It can furthermore be provided that the first access point 518 determines, according to the delay, when the first access point 518 sends a trigger for the first radio channel, or when a time window via the bridge 502 is available for the first radio channel.

For example, the information 608 comprises the maximum number of users.

If the communication network comprises the second access point 520, which provides the second radio channel that leads to interference in the first radio channel, it can be provided that the information 608 indicates that the second access point 520 provides the second radio channel that leads to interference in the first radio channel.

If the first access point 518 is configured to provide the identification of the second access point 520 along with the indicator for the strength of the interference, it can be provided that the information 608 comprises the indicator and the identification of the second access point 520.

The method comprises a step 708.

In step 708, the information 608 is transmitted from the first access point 518 to the unit 606.

It can be provided that the request 616 of the application for transmitting data via the communication network is provided to the unit 606.

It can be provided that the unit 606 also receives information 608 from the second access point 520, which information characterizes a property of the second radio channel or of the second access point 520. The second access point 520 is configured, e.g., as described for the first access point 518.

The property of the second radio channel comprises, e.g., a maximum number of users of the second radio channel. The property of the second access point 520 comprises, e.g., a maximum number of users of the second access point 520.

The property of the second radio channel or of the second access point 520 indicates, e.g., that the first radio channel leads to interference in the second radio channel.

The property of the second radio channel or of the second access point 520 characterizes, e.g., a duration of a delay until the start of a transmission by the second access point 520 via the second radio channel.

The method comprises a step 710.

In step 710, the input variable 602 is determined according to the information 608.

It can be provided that the input variable 602 is determined according to the request 616.

The input variable 602 comprises, e.g., the condition 612 or the optimization objective 614 for the scheduler 604.

The method comprises a step 712.

In step 712, the input variable 602 is provided to the scheduler 604.

The input variable 602 is provided to the scheduler 604, for example, prior to an initial assignment of the resources by the scheduler 604.

According to the first example 610-A, the information 608 is, for example, received in the unit 606 in the central control unit 504, and the input variable 602 is determined in the unit 606 according to the received information 608.

According to the second example 610-B, the information 608 is received in the unit 606 outside the central control unit 504, and the input variable 602 is determined in the unit 606 according to the received information.

The unit 606 can be configured to receive the information 608 from a plurality of access points and to determine the input variable 602 according to the information 608 received from the plurality of access points.

The method can provide that the input variable 602 is provided to the scheduler 604 in the central control unit 504. The method can provide that the input variable 602 is provided to the scheduler 604 outside the central control unit 504.

The scheduler 604 is, e.g., configured to avoid the simultaneous scheduling of a time window for the first access point 518 and a time window for the second access point 520 if the information 608 comprises the indicator and the identification of the second access point 520.

The scheduler 604 is, e.g., configured to avoid the simultaneous scheduling of a time window for transmitting time-critical frames for the first access point 518 and a time window for the second access point 520 if the information 608 comprises the indicator and the identification of the second access point 520.

The scheduler 604 is, e.g., configured to avoid the simultaneous scheduling of a time window for transmitting time-critical frames for the first access point 518 and a time window for transmitting time-critical frames for the second access point 520 if the information 608 comprises the indicator and the identification of the second access point 520.

The scheduler 604 is, e.g., configured to avoid the simultaneous scheduling if the indicator exceeds a threshold value.

The scheduler 604 is, e.g., configured to assign different time resources or different frequency resources to the access points 518, 520 for transmitting frames if the information 608 comprises the indicator and the identification of the second access point 520. The scheduler 604 is, e.g., configured to assign different resources if the indicator exceeds a threshold value.

The central control unit 504 is, e.g., configured to control the access points 518, 520 for transmitting frames by means of reduced power if the information 608 comprises the indicator and the identification of the second access point 520. The central control unit 504 is, e.g., configured to control transmission using reduced power if the indicator exceeds a threshold value.

The central control unit 504 is, e.g., configured to control the access points 518, 520 for transmitting frames by means of coordinated beamforming in non-interfering beams if the information 608 comprises the indicator and the identification of the second access point 520. The central control unit 504 is, e.g., configured to perform coordinated beamforming if the indicator exceeds a threshold value.

The method can provide control of the communication network by the scheduler 604 or the central control unit 504 according to the input variable 602.

What is claimed is:

1. A method for providing an input variable for a scheduler for a wireless communication network, wherein the communication network includes a first access point and a bridge for time-synchronized and deterministic communication, wherein the first access point is configured to provide a first radio channel for communication, wherein the first radio channel includes the bridge, the method comprising the following steps:
receiving information, wherein the information includes a property of the first radio channel or of the first access point;
determining the input variable according to the property, wherein the input variable includes a condition for the scheduler or an optimization objective for the scheduler; and
providing the input variable to the scheduler.

2. The method according to claim 1, wherein the first access point makes possible, up to a maximum number of users, a simultaneous transmission of data of a plurality of users, wherein the property includes the maximum number of users.

3. The method according to claim 1, wherein the communication network includes a second access point, wherein the property indicates that the second access point provides a second radio channel that leads to interference in the first radio channel.

4. The method according to claim 1, wherein the property characterizes a duration of a delay until a start of a transmission by the first access point via the first radio channel.

5. The method according to claim 1, wherein the communication network includes resources for providing radio channels, and the scheduler is configured to assign, to a data stream, the resources for transmitting the data stream in the communication network according to the input variable, wherein the input variable is provided to the scheduler prior to an initial assignment of the resources.

6. The method according to claim 1, wherein a request of an application for transmitting data via the communication network is provided, and wherein the input variable is determined according to the request.

7. The method according to claim 1, wherein:
(i) the information includes a property of another radio channel, and the input variable is determined according to the property of the other radio channel, or (ii) the information includes a property of another access point, and the input variable is determined according to the property of the other access point,
the property includes a maximum number of users of the other access point or the other radio channel, or the property indicates that the first radio channel leads to interference in the other radio channel, or the property characterizes a duration of a delay until a start of a transmission by the other access point via the other radio channel.

8. The method according to claim 1, wherein the information is received in a unit in a central control unit for the communication network, the input variable is determined in the unit according to the received information, and the input variable is provided to the scheduler.

9. The method according to claim 1, wherein the information is received in a unit outside a central control unit for the communication network, the input variable is determined in the unit according to the received information, and the input variable is provided to the scheduler.

10. A method for providing information for an input variable for a scheduler for a wireless communication network, the method comprising the following steps:
measuring data with respect to a first radio channel for determining the information, by a first access point, the first access point providing the first radio channel;
evaluating by the first access point, the measured data;
generating the information by the first access point;
sending the information by the first access point, wherein the information includes at least one property of the first radio channel or of the first access point, wherein the data characterize the property.

11. The method according to claim 10, wherein the data and the property characterize at least one of:
an interference in the first radio channel including an indicator for the interference,
a duration of a delay until a start of a transmission by the first access point via the first radio channel,
transmissions on the first radio channel including a percentage or a distribution of time in which transmission via the first radio channel is performed or is not performed,
a maximum number of users of the first access point,
a frequency band currently used by the first access point,
a current property of the communication network in an environment of the first access point,
a property of a user of the first access point, or
an identification of a second access point that provides a second radio channel causing the interference in the first radio channel.

12. A device configured to provide an input variable for a scheduler for a wireless communication network, wherein the communication network includes a first access point and a bridge for time-synchronized and deterministic communication, wherein the first access point is configured to provide a first radio channel for communication, wherein the first radio channel includes the bridge, and wherein the device is configured to:
receive information, wherein the information includes a property of the first radio channel or of the first access point;
determine the input variable according to the property, wherein the input variable includes a condition for the scheduler or an optimization objective for the scheduler; and
provide the input variable to the scheduler.

13. A device configured to provide information for an input variable for a scheduler for a wireless communication network, the device configured to:
measure data with respect to a first radio channel for determining the information, by a first access point, the first access point providing the first radio channel;
evaluate by the first access point, the measured data;
generate the information by the first access point;
send the information by the first access point, wherein the information includes at least one property of the first radio channel or of the first access point, wherein the data characterize the property.

14. A non-transitory storage medium on which is stored a computer program including instructions for providing an input variable for a scheduler for a wireless communication network, wherein the communication network includes a first access point and a bridge for time-synchronized and deterministic communication, wherein the first access point is configured to provide a first radio channel for communication, wherein the first radio channel includes the bridge, the instructions, when executed by a computer, causing the computer to perform the following steps:
receiving information, wherein the information includes a property of the first radio channel or of the first access point;
determining the input variable according to the property, wherein the input variable includes a condition for the scheduler or an optimization objective for the scheduler; and
providing the input variable to the scheduler.
